(19) United States
(12) Patent Application Publication
(10) Pub. No.: US 2016/0076783 A1
(43) Pub. Date: Mar. 17, 2016

(54) INTERACTIVE A/C SERVICE GAUGE SYSTEM

(71) Applicant: Troy Whitehead, Grapeland, TX (US)

(72) Inventor: Troy Whitehead, Grapeland, TX (US)

(21) Appl. No.: 14/484,254

(22) Filed: Sep. 11, 2014

(51) Int. Cl. F24F 11/00; H04Q 9/00

(52) U.S. Cl. CPC F24F 11/001; H04Q 9/00; F24F 2011/0091

(57) ABSTRACT

An interactive service gauge system for servicing an air conditioning system. The system includes a sending unit configured to releasably couple to the air conditioning system. The sending unit includes a sensor configured to generate an electrical signal representative of the performance of the air conditioning system and a control board configured to receive the electrical signal from the sensor and wirelessly transmit electrical signal data to a handheld electronic device. The handheld electronic device is configured to wirelessly receive the electrical signal data from the control board and analyze the electrical signal data to generate and display performance data of the air conditioning system. The performance data is then optionally wirelessly transmitted to a third party for remote storage, analysis, and observation.

### BACKGROUND

1. Field of the Invention

The present application relates generally to A/C servicing equipment and, more particularly, to an interactive service gauge system for servicing A/C units.

2. Description of Related Art

Temperature levA/C systems typically require routine maintenance and servicing to maintain designed levels of efficiency and effectiveness. Such maintenance and servicing may also have an effect on the longevity of the A/C systems, being that keeping an A/C system in better condition may allow the system to remain useful for a longer period than without maintenance and servicing.

To perform maintenance and service on A/C systems, technicians generally employ specialty equipment suited for specific tasks. Depending on the tasks the technician needs to perform, he may have to employ more than one A/C system service tool. Such tools may include one or more of a recovery machine, a refrigerant scale, a vacuum pump, a refrigerant recovery tank, etc. Commonly, a technician may use a manifold gauge set to couple an A/C system service tool with the A/C system, and to monitor and regulate the refrigerant flow to and from the A/C system. Manifold gauge sets are manually controlled and monitored by the technician. They are also bulky having a plurality of hoses at numerous ports. A number of hoses are only used when charging, evacuation, or use of a vacuum pump is necessary.

Depending on the maintenance and service to be performed on and A/C system, and other factors, traditional manifold gauges bulky. Additionally, data received when servicing the A/C system is locally recorded either electronically or by hand (manually by the technician).

It is desirable to provide a system, for example, an interactive A/C service gauge system for simplifying the maintenance of the A/C system and compiling the performance data. Considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a view of an interactive A/C service gauge system according to the preferred embodiment of the present application;

FIG. 2 is a schematic of an exemplary handheld electronic device used in the interactive A/C service gauge system of FIG. 1;

FIGS. 3 and 4 are side views of a sending unit in the interactive A/C service gauge system of FIG. 1; and

FIGS. 5-7 are exemplary side views of the interactive A/C service gauge system of FIG. 1 in operation.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The interactive A/C service gauge system of the present application is designed to simplify the bulky traditional manifold systems used by servicemen and allow for the more efficient collection and presentation of performance data related to individual air conditioning systems. The system of the present application is configured to releasably connect to an air conditioning system from a single attachment location, without the use of a manifold (i.e. 4-way manifold). The information gathered from the A/C system is transmitted to an electronic device for analysis and selective transmission to remote locations for storage and additional review.

The interactive A/C service gauge system of the present application will now be described with reference to the drawing figures, in which like reference numerals refer to like parts throughout.

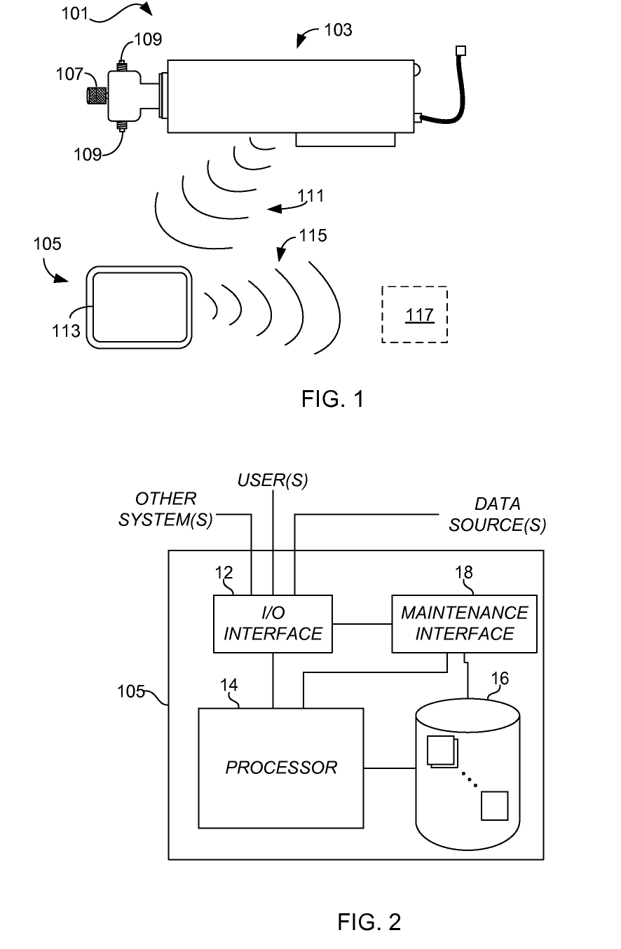

Referring now to FIG. 1 in the drawings, an interactive A/C service gauge system 101 is illustrated. System 101 includes at least a sending unit 103 and a handheld electronic device 105. Unit 103 is configured to releasably couple to an A/C port in the air conditioning system at either the low pressure side or the high pressure side. An attachment fitting 107 is located at one end of unit 103 and is designed to couple directly to the A/C port so as to avoid use of an external hose. It is contemplated and understood that attachment between system 101 and the A/C system may include the use of a hose between the A/C port and attachment fitting 107. The hose is optional but not required.

Two service ports 109 are adjacent attachment fitting 107. Each service port 109 is designed to be one part of a two part connection, wherein service port 109 is the “male” end. Service ports 109 are used during processes for charging, evacuation, and vacuum of the air conditioning system. For general diagnosis or compilation of performance data, service ports 109 are not typically necessary. Service ports 109 coupled to and apart of the sending unit configured to selectively permit the flow of working fluid through the sending unit. Each service port 109 is in communication with the attachment fitting 107 and one or more transducers, described below. Service ports 109 are configured for attachment by a hose during at least one of evacuation, charging, and vacuum of the working fluid in the air conditioning system.

Sending unit 103 gathers information and/or data from the air conditioning system and surrounding environment in order to generate electrical signal data. Sending unit 103 compiles and processes individual signals from one or more sensors and wirelessly transmits the signal data 111 to handheld electronic device 105 where the signal data is processed and analyzed by a central processor to generate the performance data of the air conditioning system. This performance data is based upon many factors, including: temperature and pressure of the working fluid within the air conditioning system, ambient environmental conditions, and A/C system characteristics, to name a few. The performance data is then displayed on a display 113 for review by a user. Device 105 can then optionally wirelessly transmits the performance data 115 to one or more third party 117 remote locations. Gauges used in traditional manifold based systems are removed. Performance data displayed may be in the familiar context of gauges traditionally used by users in the A/C industry but may also be modified to suit personal preference.

It is important to note that sending unit 103 is designed to be compact, used to gather information and then wirelessly transmit signal data 111 to device 105 for processing. This compact design permits sending unit 103 to directly access A/C ports without the use of a manifold or hose. The compact design also lessens overall weight and eliminates the need for extraneous hoses to monitor and measure the performance of the air conditioning system.

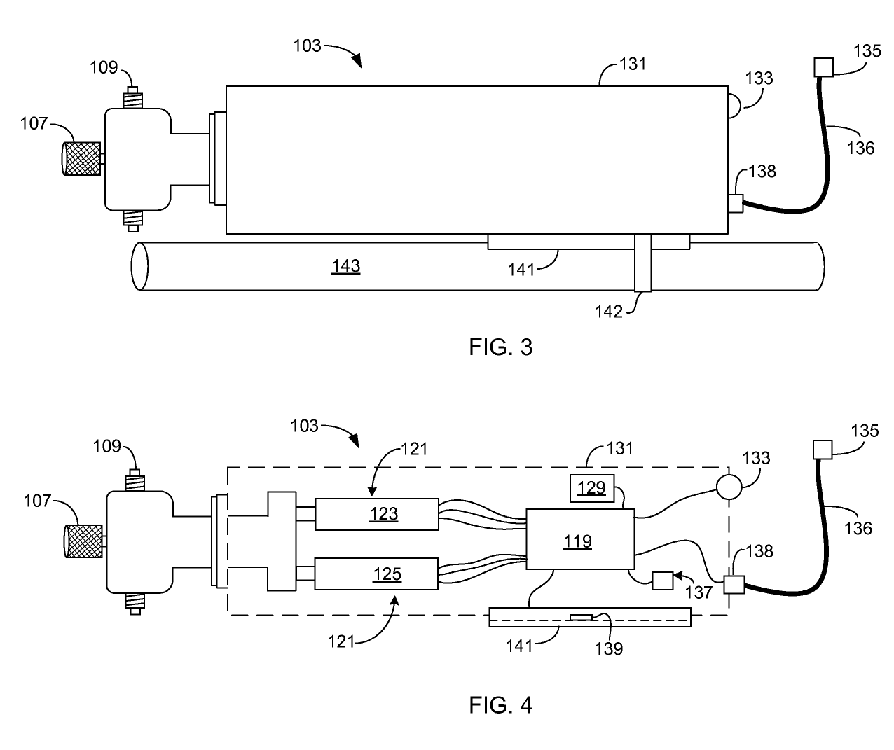

Referring now also to FIG. 2 in the drawings, a schematic of device 105 is illustrated. FIG. 2 illustrates an exemplary configuration and design for device 105 used to receive and process signal data from sending unit 103 to generate performance data for the air conditioning system. For example, device 105 may generate super heat and sub cooling readings based upon tabular data in relation to the received signal data 111 received from sending unit 103.

The device 105 includes an input/output (I/O) interface 12, a processor 14, a database 16, and a maintenance interface 18. Alternative embodiments can combine or distribute the input/output (I/O) interface 12, optimization engine 14, database 16, and maintenance interface 18 as desired. Embodiments of device 105 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example smart phones, electronic tablets, and computer workstations, that are suitable for also performing other tasks. Furthermore the computers and machines may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of device 105. The I/O interface 12 can be configured for allowing one or more users to input information to device 105 via any known input device, such as display 113. Examples can include a keyboard, mouse, touch screen, microphone, and/or any other desired input device. The I/O interface 12 can be configured for allowing one or more users to receive information output from device 105 via any known output device. Examples can include a display monitor, a printer, a speaker, and/or any other desired output device. The I/O interface 12 can be configured for allowing other systems to communicate with device 105. For example, the I/O interface 12 can allow one or more remote computers to access information, input information, and/or remotely instruct device 105 to perform one or more of the tasks described herein. The I/O interface 12 can be configured for allowing communication with one or more remote data sources, such as third party 117. For example, the I/O interface 12 can allow third party 117 to receive performance data transmitted by one or more ways, including: fax, text, email, cloud based upload/download (i.e. world-wide web), to name a few. Performance data 115 may be viewed and modified via I/O interface 12 to adjust format, presentation, and structure of the performance data.

The database 16 provides persistent data storage for device 105. While the term “database” is primarily used, a memory or other suitable data storage arrangement may provide the functionality of the database 16. In alternative embodiments, the database 16 can be integral to or separate from device 105 and can operate on one or more computers. The database 16 preferably provides non-volatile data storage for any information suitable to support the operation of device 105. Database 16 stores information used in the generation of performance data. Examples may include, tabular scientific data, formatting data, equations, client information, checklists, registration data, unit conversions, and so forth.

The maintenance interface 18 is configured to allow users to maintain desired operation of device 105. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of processor 14 and/or the I/O interface 12. This can include, for example, software updates and/or administrative tasks such as security management and/or adjustment of certain tolerance settings.

The processor 14 is configured to receive the electrical signal data 111 and generate performance data representative and particular to a specific A/C system. Processor 14 may access and compare information stored on database 16 for producing such performance data. Processor 14 can include various combinations of one or more processors, memories, and software components.

Some functions of device 105 allow the user to not only read performance characteristics of the air conditioning system but also generate reports for clients automatically, auto transmit performance data 115 to a third party through one of the methods disclosed above, store client and A/C unit histories, access the internet, and receive technical support and instructions based upon performance data. The technical support can be pre-stored on device 105 to provide basic and general support given particular conditions of the air conditioning system, but device 105 may also receive customized technical support wirelessly from third party 117. This instantaneous and customized support can enable the user to be more efficient, more accurate in diagnosis, and knowledgeable regarding service methods and techniques.

Although FIG. 2 is used to describe the functions and features of device 105, it is understood that sending unit 103 may contain some of the same features, including a processor, database for storage, and I/O interface to permit the transmission of data to device 105.

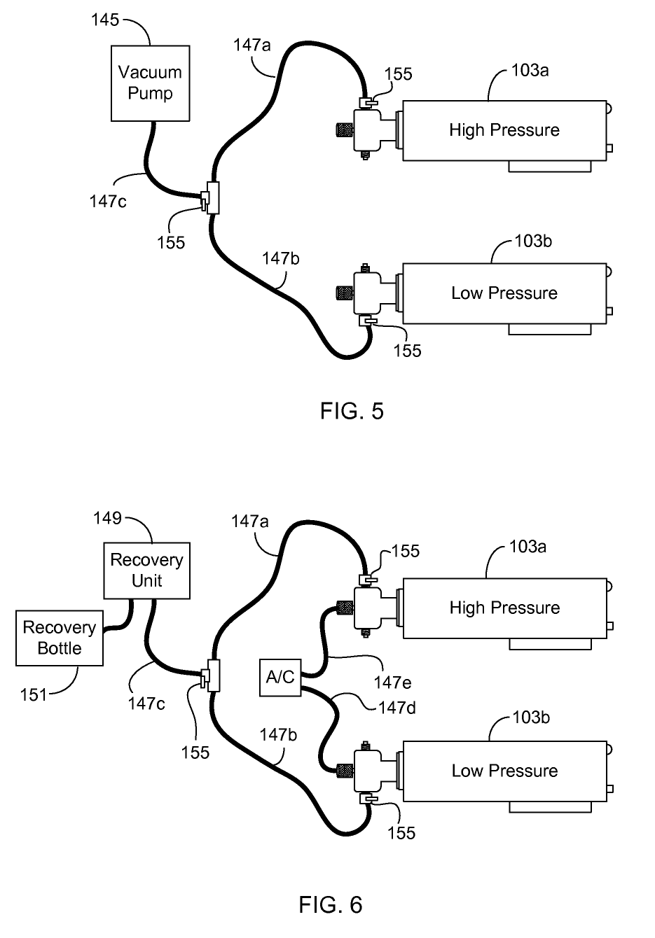

Referring now also to FIGS. 3 and 4 in the drawings, sending unit 103 is illustrated in more detail. Sending unit 103 includes a control board 119 and a sensor. The sensor is configured to generate an electrical signal representative of the performance of the air conditioning system. The control board is configured to receive the electrical signal from the sensor and produce electrical signal data. The signal data 111 is wirelessly transmitted by the control board 119 to device 105. It is understood that one or more sensors may be used. Sending unit 103 is illustrated with a plurality of sensors, including transducers 121 and thermistors 135, 137, 139.

Transducers 121 convert a signal from one form of energy to another form of energy, such as electrical and mechanical. Transducers 121 measure the pressure within the air conditioning system and relay an electrical signal to control board 119 in representation of that pressure reading. Sending unit 103 includes two different transducers 121: a high pressure transducer 123 and a low pressure transducer 125. High pressure transducer reads pressure values in the range of 0-800 psi. The low pressure transducer 125 reads pressures in the range of 0-0.1 micron psi. A series of wires 127a, 127b electrically connect transducers 121 with control board 119.

A power supply 129 is used within sending unit 103 to provide power to the various components: control board 119 and the various sensors. As shown, the power is routed through control board 119 to each sensor. Power supply 129 is ideally a type of battery. The battery may be either rechargeable or disposable. A housing 131 surrounds a number of the sensors, the control board 119 and the power supply 129. The housing is sealed to prevent exposure to harsh elements in the environment, such as water, dirt, dust, and grease to name a few. An on/off switch 133 is coupled to housing 131, partially extending externally. Switch 133 is configured to permit the user to regulate power to the sensors. It is understood that some embodiments may route power from power supply 129 through switch 133 and then to control board 119 in an attempt to simplify wiring. Although the routing of specific wiring paths are illustrated in the drawings, it is understood that such paths are not limiting. Routing may be varied to compliment various design parameters and preferences.

As seen in FIG. 4, particularly, sending unit 103 is illustrated having 3 separate thermistors (sensors). Thermistors are used to measure temperatures, acting as a temperature sensor. Each thermistor is configured to generate an electrical signal to the control board 119 representative of temperature. Each of the three thermistors are used to measure the temperature in different areas. An example of a thermistor that may be used with system 101 is a k-type thermistor. First, thermistor 135 is configured to extend from housing 131 and is used to measure line temperatures as an option. As seen in the figures, thermistor 135 is coupled to a port 138 and extends from port 138 a distance (i.e. 3 feet) via cable 136. In some embodiments, thermistor 135 is releasably coupled or removable from port 138. Additionally, thermistor 135 may also be retractable within housing 131 by the application of a force along cable 136.

Thermistor 137 is internally located within housing 131 and in communication with control board 119. Thermistor 137 measures the ambient temperature within housing 131. Lastly, thermistor 139 is located externally to housing 131 but is located adjacent a surface of housing 131. Thermistor runs approximately parallel along 131 and is used to measure the line temperature.

Thermistor 139 is externally coupled along a surface of housing 131. Thermistor 139 is configured to measure the temperature of the working fluid within the air conditioning system. To do this, thermistor 139 is placed adjacent either a suction line or a discharge line of the A/C system. An adaptable layer 141 (i.e. foam or elastomeric material) is coupled around thermistor 139 and to housing 131. The exterior surface of the adaptable layer is contoured to the shape of a system line 143, such as the suction line and the discharge line. Straps 142 may be included to ensure that sending unit 103 is secured to the lines 143 when thermistor 139 is used.

Control board 119 and its associated functions have been described above in relation to the other components of system 101. Control board 119 is an integrated circuit board having at least a voltage regulator and a wireless communication device (i.e. Bluetooth compatibility). Control board 119 is configured to receive the electrical signals from each of the sensors and produce electrical signal data. The electrical signal data is then wirelessly transmitted to device 105. The compilation and transmission of electrical signal data occurs in real time while sending unit 103 is powered in an “on” configuration. Control board 119 is synced to that of device 105 and data is transmitted. Device 105 then processes the electrical signal data in real time and continuously produces performance data related to the air conditioning system. That performance data is stored as needed within device 105 or is optionally transmitted to third party 117.

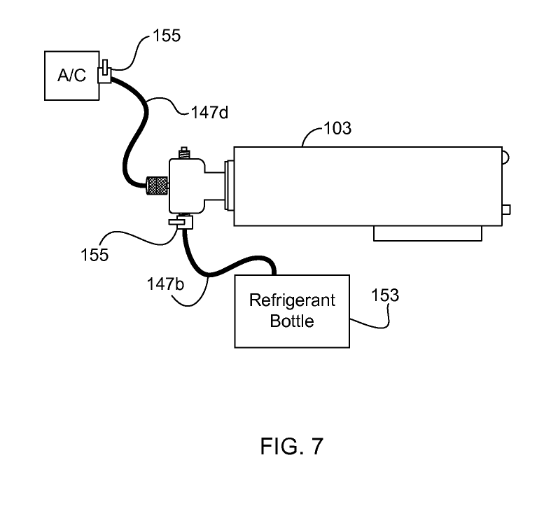

Referring now also to FIGS. 5-7 in the drawings, wherein system 101 is illustrated as including the simultaneous operation of two sending units with an air conditioning system. To this point, a single sending unit 103 has been described in measuring the performance of an air conditioning unit (A/C unit). To do this, sending unit 103 would be coupled to the low pressure side of the A/C unit. It is understood that some procedures or maintenance activities for an A/C unit may require use of two sending units 103a, 103b. Each sending unit is similar in form and function to that of sending unit 103. For purposes of illustration, not all of the represented components of sending unit 103 may be illustrated.

When two sending units are used, one is coupled to the low pressure side and the other is coupled to the high pressure side. A single sending unit is not coupled to both pressure sides. As seen in the figures, the lack of a manifold is not a hindrance to performance of system 101. Service ports 109 provide the necessary attachment locations necessary to perform typical procedures, such as evacuation, vacuuming, and charging of the A/C unit. Additionally, each sending unit is in wireless communication with device 105, with each transmitting associated electrical signal data. Device 105 is configured to communicate with a plurality of sending units simultaneously.

FIG. 5 illustrates the use of multiple sending units in communication with a vacuum pump 145. In this example, separate hoses 147a-b are coupled to a service port 109 of each sending unit. The hoses 147a-b are combined at a junction. Hose 147c extends from the junction to the vacuum pump 145. In FIG. 6, multiple sending units are in communication with a recovery unit 149 and recovery bottle 151 for the evacuation of the working fluid from the A/C unit. Additional hoses 147d-e are coupled to the attachment fitting 107 for communication directly to the A/C unit. Hoses 147a-c are used in a similar configuration as seen in FIG. 5. FIG. 7 illustrates the use of a single sending unit 103 in communication with working fluid stored in a refrigeration bottle 153. Hose 147b extends from bottle 153 to service port 109. Hose 147d extends from attachment fitting 107 to port on the A/C unit. Hose 147d is able to be used when checking the A/C unit in place of directly coupling fitting 107 to the service port of the A/C unit as described above. Hoses 147a-e are optionally included within system 101 and may optionally be selectively colored to have a symbolic representation (i.e. type of refrigerant for example).

As seen in FIGS. 5-7, system 101 is configured to minimize the loss of working fluid to the environment. One way this is seen is in the configuration of hoses 147a-d and service ports. Typical manifolds have integral ball valves wherein the hoses are merely connected. In system 101, service ports are “male end” connectors and the ball valve control 155 is located on the hose. Hoses 147a-c are configured to remain with the associated container/pump/unit/bottle. Any extra working fluid within the hoses are contained within the hoses at the time the hoses are disconnected from the service port 109 because the ball valve control 155 is used to internally seal the working fluid within the respective hose. The location of the ball valve control 155 on the hoses allows a user or serviceman to forgo the need of carrying multiple hoses and large manifold during routine maintenance and evaluation trips to each unit. System 101 uses a compact and versatile sending unit 103 that is able to maintain and evaluate the performance of an A/C unit without a manifold and the need to carry multiple hoses. Additionally, system 101 is configured to minimize leakage of the working fluid to the environment.

The current application has many advantages over the prior art including at least the following: (1) no need for external manifold; (2) evaluation and maintenance of A/C unit without the need for unnecessary hoses; (3) ball valve control on the hose as opposed to the unit itself to internally seal the working fluid within the hose; (4) compact design; (5) wireless communication with handheld electronic device; and (6) wireless communication of performance data from the handheld electronic device to a third party.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A service gauge system for servicing an air conditioning system, comprising:
a sending unit configured to releasably couple to the air conditioning system, the sending unit having:
a sensor configured to generate an electrical signal representative of the performance of the air conditioning system; and
a control board configured to receive the electrical signal from the sensor and wirelessly transmit electrical signal data; and
a handheld electronic device configured to wirelessly receive the electrical signal data from the control board, the handheld electronic device configured to analyze the electrical signal data to generate and display performance data of the air conditioning system, the handheld electronic device configured to wirelessly transmit the performance data for remote storage and observation.

2. The service gauge system of claim 1, wherein the sending unit is configured without a manifold, thereby permitting the sending unit a single attachment fitting for connecting to at least one of a high pressure line and a low pressure line of the air conditioning system.

3. The service gauge system of claim 1, wherein the performance data is generated from the signal data transmitted from the sending unit when coupled to a low pressure side of the air conditioning unit.

4. The service gauge system of claim 3, further comprising:
a second sending unit coupled to a high pressure side of the air conditioning unit, the second sending unit configured to also receive electrical signals and wirelessly transmit electrical signal data to the handheld electronic device;
wherein the handheld electronic device is in wireless communication with both the sending unit and the second sending unit simultaneously.

5. The service gauge system of claim 4, wherein the handheld electronic device is configured to process performance data from the sending unit and the second sending unit simultaneously.

6. The service gauge system of claim 1, wherein the sensor is a transducer configured to generate the electrical signal as a result of the pressure of the working fluid within the air conditioning system.

7. The service gauge system of claim 6, wherein the transducer is at least one of a pressure transducer and a vacuum transducer.

8. The service gauge system of claim 1, wherein the sensor is a thermistor configured to provide the electrical signal to the control board, the thermistor being coupled to a housing of the sending unit, the thermistor measuring temperature.

9. The service gauge system of claim 8, wherein the thermistor is externally coupled along a surface of the housing, the thermistor being configured to contour to at least one of a suction line and a discharge line of the air conditioning system, so as to measure the temperature of working fluid within the air conditioning system.

10. The service gauge system of claim 8, wherein the thermistor is selectively detachable from an external port in the housing, the thermistor is configured to provide the electrical signal to the control board representative of environmental conditions used to determine the performance data of the air conditioning unit.

11. The service gauge system of claim 8, wherein the thermistor is retractable within the housing.

12. The service gauge system of claim 8, wherein the thermistor is internally located within the housing.

13. The service gauge system of claim 2, further comprising:
a service port coupled to a housing of the sending unit configured to selectively permit the flow of working fluid through the sending unit, the service port in communication with the attachment fitting.

14. The service gauge system of claim 13, wherein the service port is configured for attachment by a hose during at least one of evacuation, charging, and vacuum of the working fluid in the air conditioning system.

15. The service gauge system of claim 14, wherein the sending unit is configured to minimize loss of the working fluid.

16. The service gauge system of claim 1, wherein the handheld electronic device is configured to process the performance data from the sending unit.

17. The service gauge system of claim 16, wherein the performance data is selectively transmitted via wireless communications to a third party.
